(19) United States
(12) Patent Application Publication
(10) Pub. No.: US 2026/0231038 A1
(43) Pub. Date: Aug. 6, 2026

(54) OPTIONAL PARAMETER VALUE FOR UPLINK WAKE UP SIGNAL

(71) Applicant: QUALCOMM Incorporated, San Diego, CA (US)

(72) Inventors: Navid ABEDINI, Basking Ridge, NJ (US); Aria HASANZADEZONUZY, Chatham, NJ (US); Jianghong LUO, Skillman, NJ (US); Hung Dinh LY, San Diego, CA (US)

(21) Appl. No.: 19/467,694

(22) Filed: Feb. 2, 2026

Related U.S. Application Data
(60) Provisional application No. 63/753,741, filed on Feb. 4, 2025.

(51) Int. Cl. H04W 52/02; H04W 74/0833

(52) U.S. Cl. CPC H04W 52/0235; H04W 52/0203; H04W 74/0833

(57) ABSTRACT

Various aspects of the present disclosure generally relate to wireless communication. In some aspects, an UE may receive an uplink (UL) wake up signal (WUS) configuration for a first cell. The UE may transmit, based at least in part on a determination that a value of an optional parameter of the UL-WUS configuration is absent, an UL-WUS that uses a value of the optional parameter determined based at least in part on an optional parameter rule. Numerous other aspects are described.

### CROSS-REFERENCE TO RELATED APPLICATION

This Patent Application claims priority to U.S. Provisional Patent Application No. 63/753,741, filed on February 4, 2025, entitled “OPTIONAL PARAMETER VALUE FOR UPLINK WAKE UP SIGNAL,” and assigned to the assignee hereof. The disclosure of the prior Application is considered part of and is incorporated by reference into this Patent Application.

### INTRODUCTION

Aspects of the present disclosure generally relate to wireless communication and specifically relate to techniques, apparatuses, and methods associated with an uplink wake up signal.

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

Some aspects described herein relate to an apparatus for wireless communication at a user equipment (UE). The apparatus may include one or more memories and one or more processors coupled with the one or more memories. The one or more processors may be configured to cause the UE to receive an uplink (UL) wake up signal (WUS) configuration for a first cell. The one or more processors may be configured to cause the UE to transmit, based at least in part on a determination that a value of an optional parameter of the UL-WUS configuration is absent, an UL-WUS that uses a value of the optional parameter determined based at least in part on an optional parameter rule.

Some aspects described herein relate to a method of wireless communication performed at a UE. The method may include receiving an UL-WUS configuration for a first cell. The method may include transmitting, based at least in part on a determination that a value of an optional parameter of the UL-WUS configuration is absent, an UL-WUS that uses a value of the optional parameter determined based at least in part on an optional parameter rule.

Some aspects described herein relate to a UE. The UE may include a processing system. The processing system may include one or more processors and one or more code-storing memories coupled with the one or more processors. The processing system may be configured to cause the UE to receive an UL-WUS configuration for a first cell. The processing system may be configured to cause the UE to transmit, based at least in part on a determination that a value of an optional parameter of the UL-WUS configuration is absent, an UL-WUS that uses a value of the optional parameter determined based at least in part on an optional parameter rule.

Some aspects described herein relate to a non-transitory computer-readable medium that stores a set of instructions for wireless communication by a UE. The set of instructions, when executed by one or more processors of the UE, may cause the UE to receive an UL-WUS configuration for a first cell. The set of instructions, when executed by one or more processors of the UE, may cause the UE to transmit, based at least in part on a determination that a value of an optional parameter of the UL-WUS configuration is absent, an UL-WUS that uses a value of the optional parameter determined based at least in part on an optional parameter rule.

Some aspects described herein relate to an apparatus for wireless communication. The apparatus may include means for receiving an UL-WUS configuration for a first cell. The apparatus may include means for transmitting, based at least in part on a determination that a value of an optional parameter of the UL-WUS configuration is absent, an UL-WUS that uses a value of the optional parameter determined based at least in part on an optional parameter rule.

Some aspects described herein relate to a network entity. The network entity may include a plurality of antennas and a processing system. The processing system may include one or more processors and one or more memories that store code for the one or more processors. The processing system may be configured to cause the network entity to determine, for a NES cell, an optional parameter for an UL-WUS by a UE based at least in part on an optional parameter rule to be applied at the UE in response to an absence of explicit indication of the optional parameter by the network entity to the UE. The processing system may be configured to cause the network entity to receive the UL-WUS from the UE in accordance with the optional parameter.

Some aspects described herein relate to a method of wireless communication performed at a network entity. The method may include determining, for a NES cell, an optional parameter for a UL-WUS by a UE based at least in part on an optional parameter rule to be applied at the UE in response to an absence of explicit indication of the optional parameter by the network entity to the UE. The method may include receiving the UL-WUS from the UE in accordance with the optional parameter.

Some aspects described herein relate to a non-transitory computer-readable medium that stores a set of instructions for wireless communication by a network entity. The set of instructions, when executed by one or more processors of the network entity, may cause the network entity to determine, for a NES cell, an optional parameter for a UL-WUS by a UE based at least in part on an optional parameter rule to be applied at the UE in response to an absence of explicit indication of the optional parameter by the network entity to the UE. The set of instructions, when executed by one or more processors of the network entity, may cause the network entity to receive the UL-WUS from the UE in accordance with the optional parameter.

Some aspects described herein relate to an apparatus for wireless communication. The apparatus may include means for determining, for a NES cell, an optional parameter for a UL-WUS by a UE based at least in part on an optional parameter rule to be applied at the UE in response to an absence of explicit indication of the optional parameter by the network entity to the UE. The apparatus may include means for receiving the UL-WUS from the UE in accordance with the optional parameter.

The systems, methods, and devices of this disclosure each have several innovative aspects, no single one of which is solely responsible for the desirable attributes disclosed herein.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example disaggregated network node architecture.

FIGS. 3A and 3B are diagrams illustrating an example of a low power wake up signal (WUS).

FIGS. 4A, 4B, and 4C are diagrams illustrating an example of determining a missing optional parameter value of an uplink wake up signal configuration.

FIG. 5 is a diagram illustrating an example process performed, for example, at a user equipment (UE) or an apparatus of a UE.

FIG. 6 is a diagram of an example apparatus for wireless communication.

FIG. 7 is a diagram illustrating an example of a hardware implementation for an apparatus employing a processing system.

FIG. 8 is a diagram illustrating an example of an implementation of code and circuitry for an apparatus.

FIG. 9 is a diagram illustrating an example process performed, for example, at a network entity or an apparatus of a network entity.

FIG. 10 is a diagram of an example apparatus for wireless communication.

FIG. 11 is a diagram illustrating an example of a hardware implementation for an apparatus employing a processing system.

FIG. 12 is a diagram illustrating an example of an implementation of code and circuitry for an apparatus.

### DETAILED DESCRIPTION

In some examples, network entities (e.g., user equipments (UEs), network nodes, and/or similar components) may have a capability to exchange wakeup signals (WUSs), such as for a purpose of alerting another network entity to wake up from a low-power state in order to transmit an on-demand signal and/or to receive a communication. A WUS is a signal used to activate or transition a device, circuit, or system from a low-power or inactive state to an operational state. The WUS may be transmitted in time and frequency resources dedicated for monitoring for a WUS. A low power radio of a device may operate with reduced power as compared to a main radio of the device and may monitor for a WUS. A WUS may be transmitted in the uplink or the downlink.

In an example, a UE may receive an UL-WUS configuration that configures the UE for UL-WUS transmission. The UL-WUS configuration may configure the UE with one or more uplink-WUS (UL-WUS) occasions, which may correspond to resources to be used for transmitting one or more UL-WUSs to a cell (sometimes referred to herein as a network energy savings (NES) cell). The term “cell” can refer to a coverage area of a network entity or to a network entity itself, depending on the context in which the term is used. An anchor cell may be a primary cell to which the UE is connected. A NES cell is a cell that is configured to consume less power than a regular (non-NES) cell on average. A NES network entity may serve the NES cell. The NES cell may transmit a system information block (SIB) one (SIB1) transmission in response to an UL-WUS from a UE. The UL-WUS may be transmitted to request that an on-demand SIB (e.g., SIB1) be transmitted by the NES cell. In such examples, the UE may be provided with an UL-WUS configuration, which may include parameters used by the UE to transmit a request for an on-demand SIB1, information used to acquire a SIB1, and/or similar information.

In some examples, an UL-WUS configuration may be a message transmitted to the UE by an anchor cell (e.g., an anchor network entity serves the anchor cell). The anchor cell may be a cell located in a vicinity of or overlaps with a NES cell and may be separate from the NES cell. The NES cell may be the cell for which the UL-WUS configuration applies. More particularly, the anchor cell may provide a message with UL-WUS configuration parameters to the UE for a particular NES cell, such that the UE can transmit an UL-WUS to the particular NES cell and wake up the NES cell. The UE may then receive a communication (e.g., a SIB1 or a similar communication) from the NES cell.

In some examples, the UL-WUS configuration may include one or more parameters to use for transmission of an UL-WUS. Some parameters of the UL-WUS configuration may indicate periods of time (sometimes referred to as UL-WUS occasions) during which the NES cell may wake up and transmit one or more synchronization signal blocks (SSBs) and/or monitor for one or more UL-WUSs from one or more UEs. Other parameters may be for a reference signal received power (RSRP) threshold for SSB (e.g., rsrp-ThresholdSSB), a physical random access channel (PRACH) index (e.g., prach-RootSequenceIndex), a subcarrier spacing (SCS) of an access message (e.g., msg1-SubcarrierSpacing), and a restricted set configuration (e.g., restrictedSetConfig), among other parameters.

In some examples, a UE may receive an UL-WUS configuration that is missing values for one or more parameters. An UL-WUS configuration parameter that may optionally have a value in an UL-WUS configuration is an optional parameter. For example, to save overhead, the network entity may transmit an UL-WUS configuration that is missing one or more values for one or more respective optional parameters. However, if the UE does not receive values for certain optional parameters in the UL-WUS configuration, the UE may not be able to transmit an UL-WUS. These certain optional parameters may be required for UL-WUS transmission, while other optional parameters are not required for UL-WUS transmission. As a result of not receiving an UL-WUS, a NES cell that is to receive the UL-WUS may not wake up in time and communications to or from the NES cell may be missed. For example, the UE may not receive system information from the NES cell. Accordingly, latency may increase for the UE when the NES cell does not wake up and transmit system information to the UE until later) and signaling resources may be wasted (signals to the NES cell from other devices (e.g., UE or another network entity) may not be received and decoded).

Various aspects relate generally to UL-WUS configurations. Some aspects relate to a UE that receives an UL-WUS configuration from an anchor cell and determines that there are missing optional parameters in the UL-WUS configuration, or that values for one or more optional parameters are absent in the UL-WUS configuration. An optional parameter may be a parameter that is not mandatory and may or may not have a value in the UL-WUS configuration. In one example, the UE may obtain the value of the optional parameter from another source (e.g., a stored default value, another configuration, a parameter value provided by a network entity of a second cell) based at least in part on an optional parameter rule. An optional parameter rule may be a rule for determining a value for an optional parameter that does not have a value in a received UL-WUS configuration. For example, the optional parameter rule may indicate that a determined value of the optional parameter (having a missing value in the UL-WUS configuration) is to be a default value obtained from stored configuration information (e.g., standard-defined). The default value may be a stored value to which the UE defaults. The determined value may be the value that is determined according to the optional parameter rule. The UE may use the default value for UL-WUS transmission. In another example, the optional parameter rule may indicate that the determined value of the optional parameter is to be obtained from a set of parameters associated with a second cell (e.g., second NES cell within connection range of the UE), such as from a random access channel (RACH) configuration or a SIB1. The second NES cell may be a reference cell from which parameters may be obtained. Accordingly, the UE may determine to use a value from the set of parameters as the determined value for the optional parameter for UL-WUS transmission. The UE may then transmit an UL-WUS to the NES cell using the determined value.

By using an optional parameter rule to determine a value for an optional parameter of a received UL-WUS configuration, where a value for the optional parameter is absent in the received UL-WUS configuration, the UE may transmit an UL-WUS to a NES cell when the UE may otherwise not be able to transmit the UL-WUS. In this way, the NES cell may receive the UL-WUS and not miss data or signaling that occurs when the NES cell is to be awake. As a result, latency is decreased and signaling resources are conserved (not wasted).

In an example, there may be an anchor network entity that provides an UL-WUS configuration to a UE for sending an UL-WUS to an NES cell (NES network entity for the NES cell). In some aspects, the network entity for the NES cell is configured to apply the same optional parameter rules as the UE when determining values for optional parameters associated with an UL-WUS. For example, when a UL-WUS configuration for a NES cell lacks explicit values for one or more optional parameters, the network entity for the NES cell utilizes a consistent set of rules to resolve the missing information. For example, the network entity may select a default value from stored configuration information, such as a standard-defined default, or may reference parameter values from another cell, such as those provided in a RACH configuration or a SIB1. By mirroring the rules applied by the UE, the network entity ensures that both the network and the UE consistently determine the same values for the optional parameters, thereby supporting reliable UL-WUS communication.

This approach allows the NES network entity to maintain synchronization with the UE regarding the configuration of UL-WUS transmissions, even in scenarios where explicit signaling of all optional parameters is absent. As a result, the NES cell can reliably receive UL-WUS transmissions from the UE, reducing the risk of missed data or signaling events and thereby decreasing latency and conserving signaling resources. The consistent application of optional parameter rules by both the network entity and the UE enhances the robustness and efficiency of UL-WUS operations in wireless communication systems.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, NES, low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

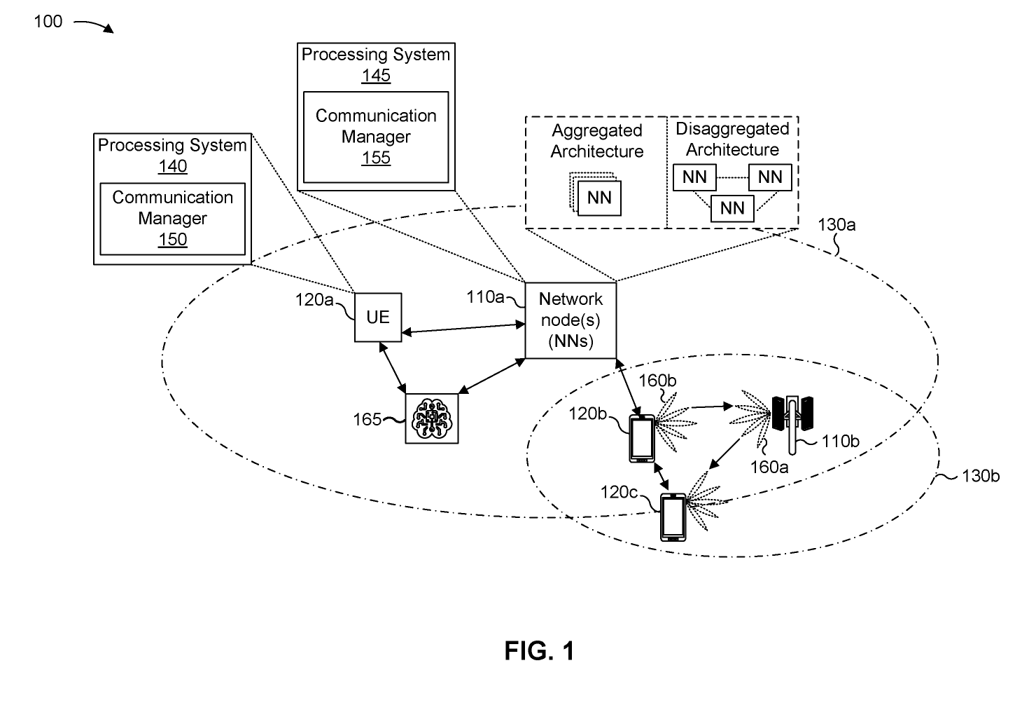

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145 (with a communication manager 155). A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or PRACH extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that have a capability for URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-RSRP parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread- orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Examples of an area may include a tracking area for idle UEs, a RAN notification area (RNA) for inactive UEs. An area may be a geographical area or an area defined by a zone. Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may receive an UL-WUS configuration for a first cell; and transmit, based at least in part on a determination that a value of an optional parameter of the UL-WUS configuration is absent, an UL-WUS that uses a value of the optional parameter determined based at least in part on an optional parameter rule. Additionally, or alternatively, the communication manager 150 may perform one or more other operations described herein.

In some aspects, a network entity (e.g., network node 110) may include a communication manager 155. As described in more detail elsewhere herein, the communication manager 155 may determine, for a NES cell, an optional parameter for an UL-WUS by the UE based at least in part on an optional parameter rule to be applied at the UE in response to an absence of explicit indication of the optional parameter by the network entity to the UE; and receive the UL-WUS from the UE in accordance with the optional parameter. Additionally, or alternatively, the communication manager 155 may perform one or more other operations described herein.

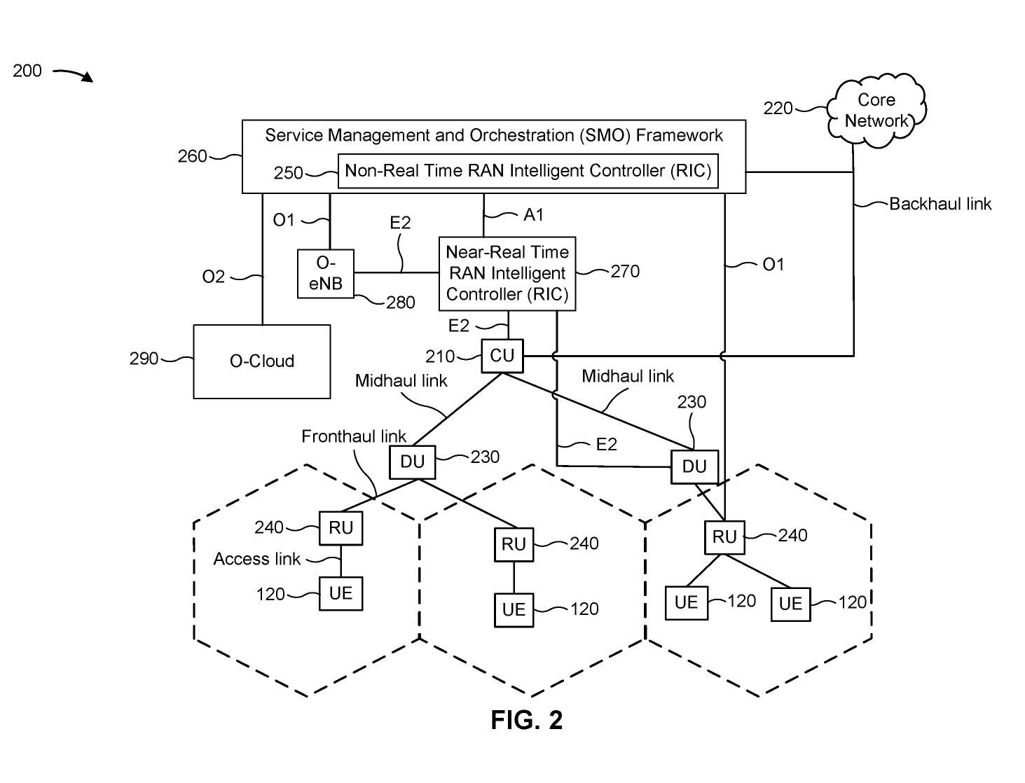

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

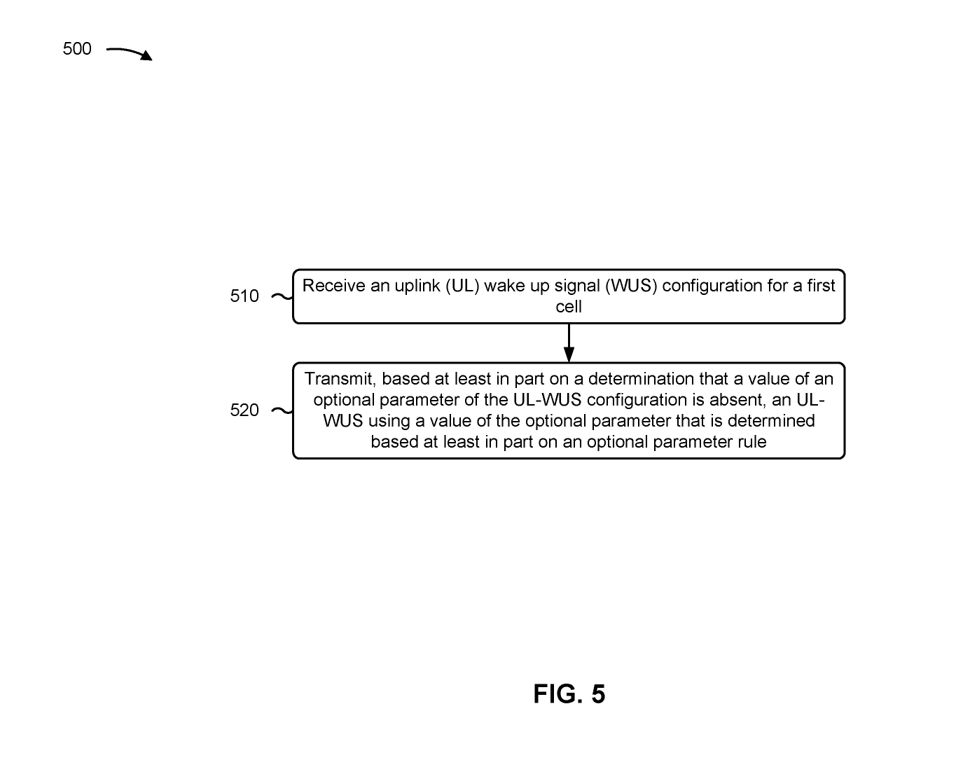

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with determining optional parameters for UL-WUS that are absent from an UL-WUS configuration, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, or other processes as described herein. In some examples, executing instructions may include running the instructions, converting the instructions, compiling the instructions, or interpreting the instructions, among other examples.

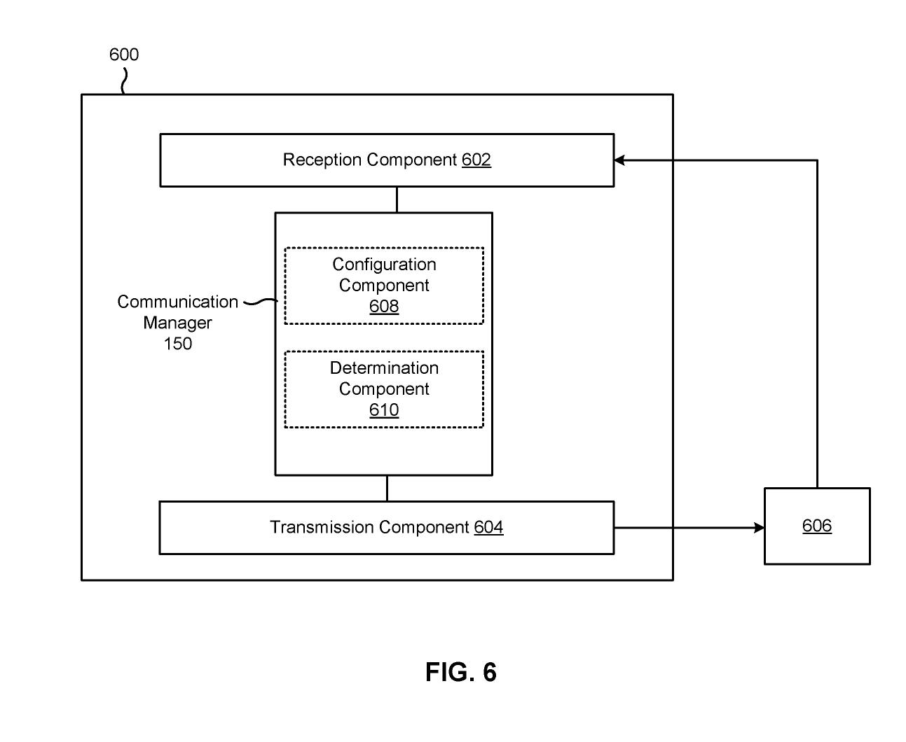

In some aspects, a UE (e.g., a UE 120) includes means for receiving an UL-WUS configuration for a first cell; and/or means for transmitting, based at least in part on a determination that a value of an optional parameter of the UL-WUS configuration is absent, an UL-WUS that uses a value of the optional parameter determined based at least in part on an optional parameter rule. In some aspects, the means for the UE to perform operations described herein may include, for example, one or more of communication manager 150, processing system 140, a radio, one or more RF chains, one or more transceivers, one or more antennas, one or more modems, a reception component (for example, reception component 602 depicted and described in connection with FIG. 6), or a transmission component (for example, transmission component 604 depicted and described in connection with FIG. 6), among other examples.

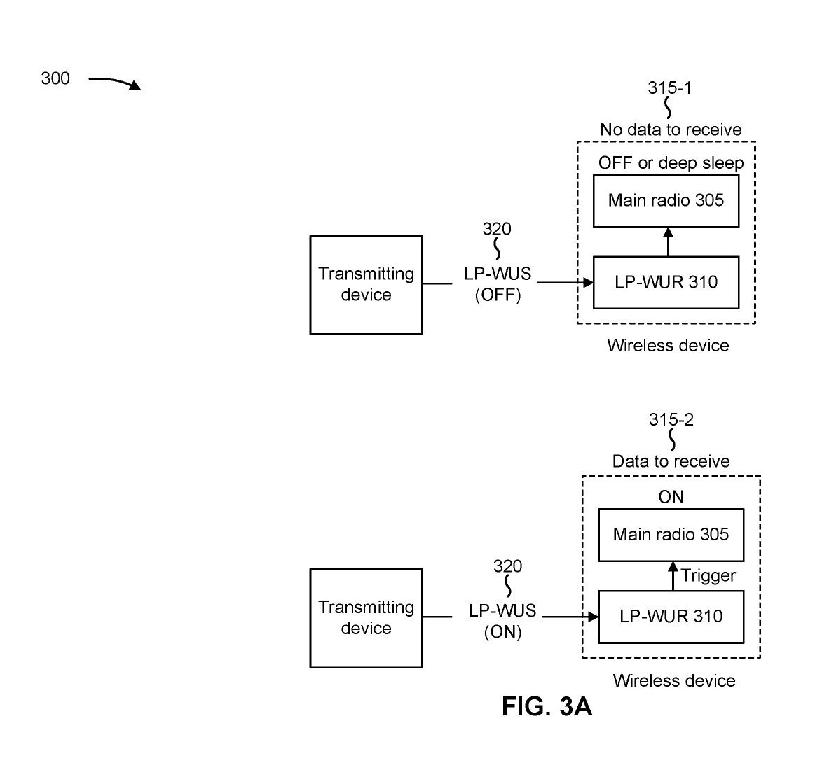

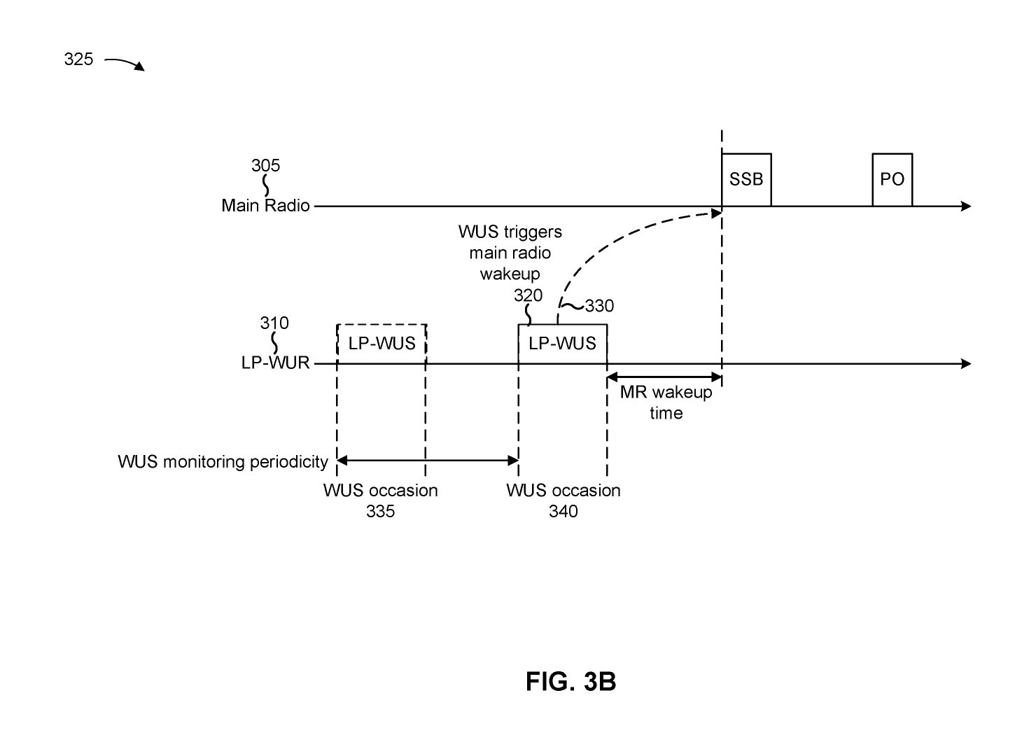

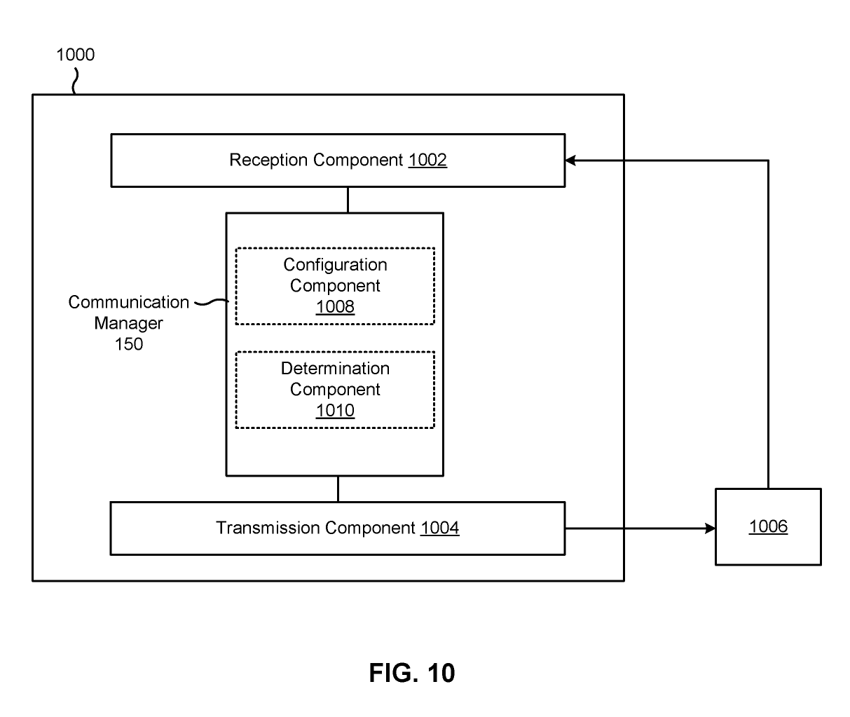

In some aspects, the network entity includes means for determining, for a NES cell, an optional parameter for an UL-WUS by a UE based at least in part on an optional parameter rule to be applied at the UE in response to an absence of explicit indication of the optional parameter by the network entity to the UE; or means for receiving the UL-WUS from the UE in accordance with the optional parameter. In some aspects, the means for the network entity to perform operations described herein may include, for example, one or more of communication manager 155, processing system 145, a radio, one or more RF chains, one or more transceivers, one or more antennas, one or more modems, a reception component (for example, reception component 1002 depicted and described in connection with FIG. 10), or a transmission component (for example, transmission component 1004 depicted and described in connection with FIG. 10), among other examples. FIG. 3A is a diagram illustrating an example 300 of a low-power wakeup radio (LP-WUR) and a low-power wakeup signal (LP-WUS). As shown in FIG. 3A, a wireless device (such as a UE 102 or a network node 110 configured for NES) may be equipped with a communication system that includes a main radio (MR) 305 and an LP-WUR 310 to reduce power consumption and enable low latency. For example, power saving and low latency are often conflicting goals because placing one or more components into a sleep state more often to reduce power consumption also increases latency (e.g., because data cannot be transmitted or received while the one or more components are in the sleep state), and because reducing the time that one or more components spend in a sleep state to reduce latency can lead to increased power consumption. Accordingly, as shown in FIG. 3A, the wireless device may be equipped with the LP-WUR 310, which may be considered a companion receiver that can be used with a main radio 305 to reduce power consumption and latency.

For example, in some aspects, the wireless device may generally use the main radio 305 to transmit or receive user data, and the main radio 305 may be turned off or operated in a deep sleep state unless there is user data to transmit or receive. Furthermore, the LP-WUR 310 may serve as a simple wakeup receiver for the main radio 305, and the LP-WUR 310 may be active and monitoring for an LP-WUS while the main radio 305 is off or in the deep sleep state. For example, reference number 315-1 depicts a first state associated with the main radio 305 and the LP-WUR 310 where there is no user data to be provided to the main radio 305. In such cases, the main radio 305 may be off or operated in the deep sleep state unless there is user data to transmit, and the LP-WUR 310 may monitor for an LP-WUS (for example, continuously, or periodically in monitoring occasions that are separated in time). Furthermore, reference number 315-2 depicts a second state associated with the main radio 305 and the LP-WUR 310 where there is user data for the main radio 305. In such cases, the LP-WUR 310 may receive an LP-WUS 320 and may provide a trigger to wake or otherwise activate the main radio 305 based on detecting the LP-WUS 320. Accordingly, the main radio 305 may then transmit or receive user data.

In general, the LP-WUR 310 may consume very little power (for example a target power consumption less than 100 microwatts (µW) in the active state), which may be achieved using simple modulation schemes (for example, on-off keying (OOK)), a narrow bandwidth (for example, less than 5 MHz), or other suitable techniques. In this way, the LP-WUR 310 can be used to reduce the time that the main radio 305 spends in an on state or may avoid unnecessarily waking the main radio 305 from the off or deep sleep state when there is no user data to transmit or receive, which tends to be costly from a power consumption perspective.

Furthermore, because the LP-WUR 310 has a very low power consumption, the LP-WUR 310 can be used to frequently or continuously perform LP-WUS monitoring (shown in FIG. 3B), which may improve latency because the main radio 305 can be woken up when there is user data that the main radio 305 needs to receive. For example, the LP-WUR 310 may not suffer from the latency versus power efficiency tradeoff associated with duty cycling schemes, such as discontinuous reception (DRX). Furthermore, in addition to performing LP-WUS monitoring, which may be used for paging reception, the LP-WUR 310 may monitor a low power synchronization signal (LP-SS) for time and frequency tracking and radio resource management (RRM) measurement. In this way, by monitoring the LP-SS, serving cell or neighbor cell monitoring can be offloaded from the main radio 305 to the LP-WUR 310 to reduce how often the main radio 305 is woken up, which can further reduce power consumption.

In some aspects, the LP-WUR 310 may include an OOK WUR (also referred to as an envelope detector (ED) WUR). An OOK WUR may only detect the amplitude (such as the magnitude) of a received signal. A wireless device that uses an OOK WUR may detect the phase of a received signal by activating the MR 305.

In some aspects, the LP-WUR 310 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

In some aspects, as shown by reference number 325, one application of the LP-WUR 310 is to monitor the LP-WUS 320 for paging monitoring, which can be used to reduce unnecessary paging reception performed by the main radio 305. For example, as shown in FIG. 3B, the LP-WUR 310 may be configured to monitor for an LP-WUS 320 (while the main radio 305 is off or in a deep sleep state) according to a WUS monitoring periodicity. For example, the LP-WUR 310 may monitor for the LP-WUS 320 in periodic LP-WUS monitoring occasions (e.g., WUS occasions 335 and 340) that are spaced in time according to the WUS monitoring periodicity. Alternatively, although not explicitly shown in FIG. 3B, the LP-WUR 310 may be configured to continuously monitor for the LP-WUS 320. In general, transmitting device (e.g., UE 120 or network node 110) may transmit an LP-WUS 320 to the wireless device only in cases where there is a paging message that needs to be sent to the wireless device while the wireless device is in an idle or inactive state (such as an RRC idle or RRC inactive state). In such cases, as shown by reference number 330, the LP-WUR 310 may receive and detect the LP-WUS 320, which may trigger the LP-WUR 310 to wake up the main radio 305. In some aspects, the LP-WUS 320 may be a sequence-based WUS, which may include a predefined set of sequences (implemented, for example, using OOK modulation or phase modulation). As shown, the main radio 305 may wake up after a main radio wakeup time, and may then start to monitor one or more synchronization signal block (SSB) transmissions to obtain synchronization with the network node before monitoring and receiving the paging message in a subsequent PO. Otherwise, in cases where the LP-WUR 310 does not detect the LP-WUS 320, the main radio 305 may remain in the deep sleep state to save power.

In some examples, network entities, UEs, network nodes, and/or similar components) have the capability to exchange WUSs, such as for a purpose of alerting another network entity or device to wake up from a low-power state in order to transmit an on-demand signal and/or to receive a communication. For example, a UE may receive an UL-WUS configuration that configures the UE for UL-WUS transmission. The UL-WUS configuration may configure the UE with one or more UL-WUS occasions, which may correspond to resources to be used for transmitting one or more UL-WUSs to a cell (sometimes referred to herein as a NES cell) in order to request that an on-demand SIB (e.g., SIB1) be transmitted by the NES cell. In such examples, the UL-WUS configuration may include information used to transmit a request for an on-demand SIB1, information used to acquire a SIB1, and/or similar information.

In some examples, an UL-WUS configuration may be a message transmitted to the UE by an anchor cell (e.g., network entity serving the anchor cell), which may be a cell located in a vicinity of or that overlaps a NES cell and that is separate from the NES cell for which the UL-WUS configuration applies. More particularly, the anchor cell may provide UL-WUS configuration information (mandatory parameters and possibly optional parameters) to the UE for a particular NES cell, such that the UE may transmit an UL-WUS to and wake up the NES cell. The UE may then receive a communication (e.g., SIB1 or a similar communication) from the NES cell.

In some examples, the UL-WUS configuration may include one or more parameters to use for transmission of an UL-WUS. Some parameters of the UL-WUS configuration may indicate periods of time (sometimes referred to as UL-WUS occasions) during which the NES cell may wake up and transmit one or more synchronization signal blocks (SSBs) and/or monitor for one or more UL-WUSs from one or more UEs. Other parameters may be for an RSRP threshold for SSB (e.g., rsrp-ThresholdSSB), a physical random access channel (PRACH) index (e.g., prach-RootSequenceIndex), a subcarrier spacing (SCS) of an access message (e.g., msg1-SubcarrierSpacing), and a restricted set configuration (e.g., restrictedSetConfig). Parameters may be for a list of frequency bands (e.g., frequencyBandList), a frequency point (e.g., absoluteFrequencyPointA), a carrier offset (e.g., offsetToCarrier), p-Max, or an uplink SCS (e.g., ULSubCarrierSpacing).

Parameters may be for a physical block channel (PBCH) block power (e.g., ss-PBCH-BlockPower), an SSB position (e.g., SSB-positionInBurst), a time division duplex (TDD) configuration (e.g., tdd-UL-DL-ConfigurationCommon), RACH occasions (e.g., rach-OccasionsSIB1), a PRACH configuration (e.g., Prach-ConfigurationIndex), a msg1 FDM (e.g., msg1-FDM), a msg1 frequency (e.g., msg1-FrequencyStart), a zero correlation configuration (e.g., zeroCorrelationZoneConfig), a preamble target power (e.g., preambleReceivedTargetPower), a preamble transmission maximum (e.g., preambleTransMax), a power ramping step (e.g., powerRampingStep), or a response window (e.g., ra-ResponseWindow).

Some other parameters may be for SSBs per RACH occasion (e.g., ssb-perRACH-Occasion), a SIB1 request period (e.g., sib1-RequestPeriod), or SIB1 request resources (e.g., sib1-RequestResources, ra-PreambleStartIndex, ra-AssociationPeriodIndex, ra-ssb-OccasiomMaskIndex).

Based at least in part on the UL-WUS configuration received from the anchor cell, the UE may transmit an UL-WUS to the NES cell, such as for a purpose of requesting an on-demand SIB (e.g., SIB1). Accordingly, in response to receiving the UL-WUS, the NES cell may wake up from a sleep state or other power-saving state in order to transmit the requested communication (e.g., SIB1).

In some examples, a UE may receive an UL-WUS configuration that is missing values for one or more parameters. A parameter that may optionally have a value in an UL-WUS configuration is an optional parameter. An optional parameter may be for a timing advance offset (n-TimingAdvanceOffset), an SSB periodicity for RACH occasion (RO) validation determination (e.g., ssb-PeriodicityServingCell), or an uplink SCS, among other examples. The anchor cell may transmit an UL-WUS configuration that is missing one or more values for one or more respective optional parameters in order to save overhead. However, if the UE does not receive values for certain optional parameters, the UE may not be able to transmit an UL-WUS. As a result, a NES cell (e.g., a network entity of the NES cell) may not wake up in time and communications may be missed. Accordingly, latency may increase (retransmissions when the NES cell wakes up later) and signaling resources may be wasted (signals to the NES cell are not received and decoded).

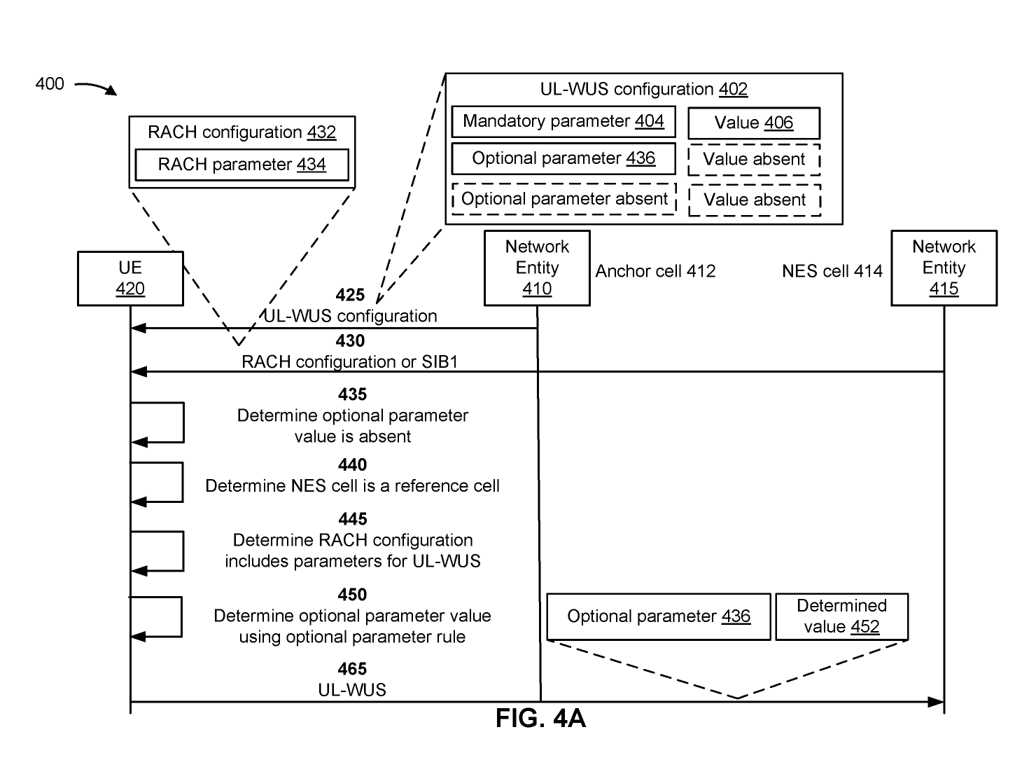

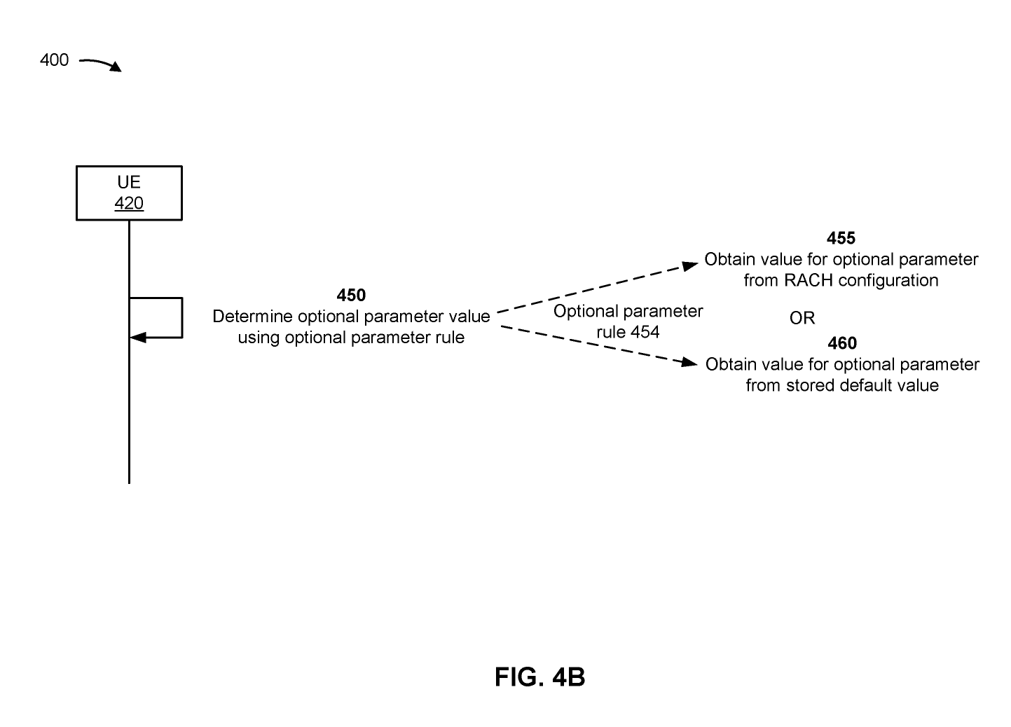

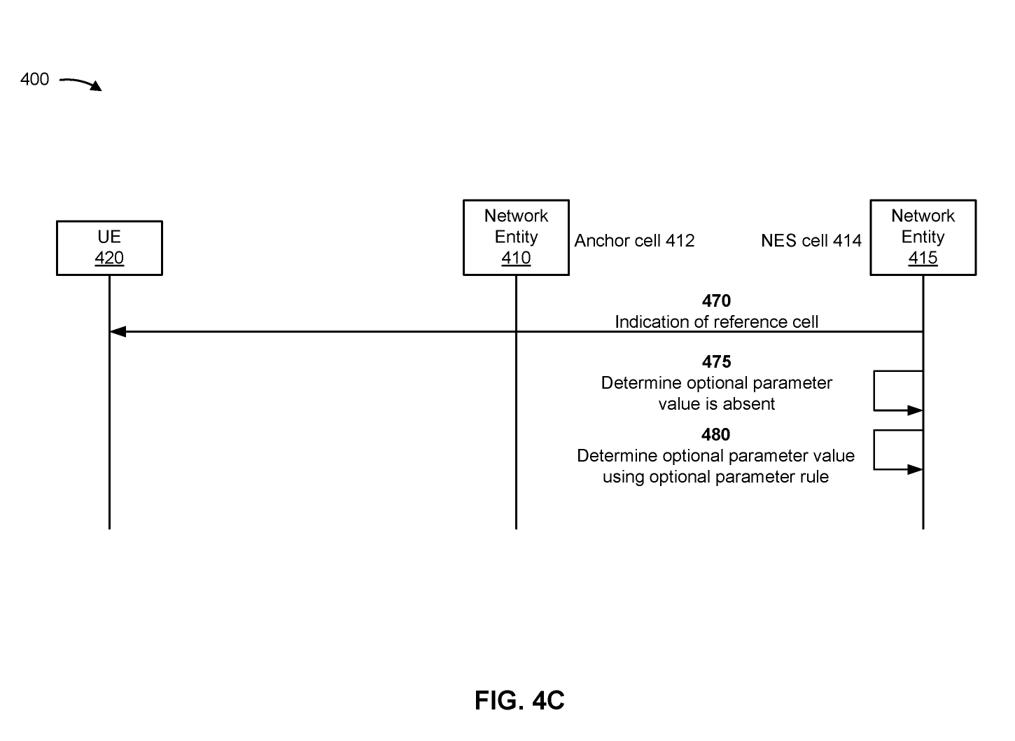

FIGS. 4A, 4B, and 4C are diagrams illustrating an example 400 of determining a missing optional parameter value of an UL-WUS configuration, in accordance with the present disclosure.

According to various aspects described herein, a UE may receive an UL-WUS configuration from a network entity of an anchor cell and determine that values for one or more optional parameters are absent from the UL-WUS configuration. Optional parameters that are missing from the UL-WUS configuration may be considered to be optional parameters with absent values. The UE may identify optional parameters (or values of the optional parameters) that are absent by comparing the parameters in the UL-WUS configuration to a stored list of mandatory parameters and optional parameters for UL-WUS configurations. The UE may obtain a value for a missing optional parameter (or for an absent value of the optional parameter) from another source based at least in part on an optional parameter rule. An optional parameter rule may be a rule for determining a value for an optional parameter that does not have a value in a received UL-WUS configuration. For example, the optional parameter rule may indicate that the determined value of the optional parameter is a default value obtained from stored configuration information (e.g., standard-defined). The UE may use the default value for UL-WUS transmission (e.g., LP-WUS 320). In another example, the optional parameter rule may indicate that the determined value of the optional parameter is to be obtained from a set of parameters associated with a second cell (e.g., NES cell or another cell), such as from a RACH configuration or a SIB1 from the second cell. In some aspects, a parameter of the set of parameters associated with the second cell may correspond to the optional parameter, in that the parameter of the set of parameters and the optional parameter may have similar characteristics or may provide sufficient information to be a substitute parameter value. There may be multiple optional parameters, and there may be multiple RACH parameters that have values or value types that can overlap with values or value types of UL-WUS parameters. That is some RACH parameters may have values that can be used as UL-WUS parameter values. The UE may determine to use a value from the set of parameters for UL-WUS transmission. The UE may transmit an UL-WUS using the determined value for the optional parameter.

By using an optional parameter rule to determine a value for an optional parameter of a received UL-WUS configuration, where a value for the optional parameter is absent in the received UL-WUS configuration, the UE may transmit an UL-WUS when the UE may otherwise not be able to transmit the UL-WUS. In this way, a NES cell (e.g., network entity of the NES cell) may receive the UL-WUS and not miss data or signaling that occurs when the NES cell is to be awake. As a result, latency is decreased and signaling resources are conserved (not wasted).

Example 400 in FIG. 4A shows a UE 420 that can communicate with a network entity 410 of an anchor cell 412 and a network entity 415 of a NES cell 414. As shown by reference number 425, the anchor cell 412 may transmit a message with an UL-WUS configuration 402 that applies to the NES cell 414. The NES cell 414 may be configured to enter an idle and/or inactive mode (e.g., discontinuous transmission (DTX) inactive mode, discontinuous reception (DRX) inactive mode, or a similar low-power mode), to reduce power consumption at the NES cell 414.

The UL-WUS configuration 402 may include multiple parameters, such as mandatory parameters (represented by mandatory parameter 404 with value 406) and optional parameters (represented by optional parameter 436). The anchor cell 412 may have determined to not include some optional parameters (or values for the optional parameters) in order to reduce overhead. FIG. 4A shows that a value is absent for optional parameter 436 in the UL-WUS configuration 402. A value is also considered to be absent for an optional parameter if the optional parameter is wholly absent from the UL-WUS configuration 402, as shown by the absent optional parameter below optional parameter 436 in the UL-WUS configuration 402. In some aspects, the NES cell 414 may have transmitted a RACH configuration or a SIB1, as shown by reference number 430. The NES cell 414 may transmit the RACH configuration or the SIB1 before or after the anchor cell 412 transmits the UL-WUS configuration.

As shown by reference number 435, the UE 420 may determine that an optional parameter value is absent from the UL-WUS configuration 402. The UE 420 may operate to determine a value for the optional parameter. As shown by reference number 440, the UE 420 may determine that the NES cell 414 is a reference cell for parameters. As shown by reference number 445, the UE 420 may determine that the RACH configuration 432 includes parameters that can be used to replace missing optional parameter values for the UL-WUS configuration 402. The anchor cell 412 or the NES cell 414 may indicate that the reference cell or the RACH configuration includes parameters that can be the determined value. The indication may be specific to a frequency band, a group of UEs, a geographic area, a duration, or a combination thereof. As shown by reference number 450, the UE 420 may determine an optional parameter value (determined value 452) using an optional parameter rule 454.

In some aspects, the optional parameter rule 454 may indicate or specify that the UE 420 is to use a comparable RACH parameter 434 from the RACH configuration 432. FIG. 4B shows that the determination of operation 450 may include different options. As shown by reference number 455 in FIG. 4B, the UE 420 may obtain the value of the RACH parameter 434 as the determined value 452 for the optional parameter 436. Alternatively, in some aspects, the optional parameter rule 454 may indicate or specify that the UE 420 is to use a default rule in stored configuration information for the determined value 452 for the optional parameter 436. As shown by reference number 460 in FIG. 4B, the UE 420 may obtain the default value as the determined value 452. For example, a default value of 20 ms or 5 ms may be used for optional parameter “ssb-PeriodicityServingCell.” In another example, in the absence of an “SSB-positionInBurst” value, the UE 420 may expect that all of the SSBs for a given cell/band are available. Returning to FIG. 4A, as shown by reference number 465, the UE 420 may transmit an UL-WUS to the NES cell 414 using the determined value 452 for the optional parameter 436.

In some aspects, the optional parameter rule may indicate or specify that values configured or indicated for other similar parameters may be applicable for the UL-WUS configuration parameters. When the UL-WUS configuration 402 (for a NES Cell 1) is provided by a second cell (e.g., Cell A or a NES cell 2) in operation 425, and some UL-WUS optional parameters do not have values in the UL-WUS configuration, the UE 420 may expect the same values configured for the similar parameters of Cell A (or NES Cell 2). Cell A may be a cell that is periodically transmitting at least its own SIB1. For example, “SSB-positionInBurst” or “SSB periodicity” of Cell A (or NES Cell 2) may be applicable to the NES cell 1 as the determined value 452. This optional parameter rule may be supported only if Cell A (NES Cell 2) operates in the same frequency/band as the NES cell 1, and/or have the same (DL and/or UL) SCS as NES Cell 1.

In another example of an optional parameter rule, when the UL-WUS configuration 402 is provided by the NES cell 414 itself (such as when operation 425 is to be performed), and some of the UL-WUS optional parameters are not configured, the UE 420 may expect the same values configured for other/similar parameters of the NES cell 414. For example, the NES cell’s SIB1 already (irrespective and outside of the UL-WUS configuration 402) provides SSB periodicity (SSB-positionInBurst), and this value can be used as the determined value 452. Moreover, the NES cell’s SIB1 also provides legacy RACH configurations (for other purposes), where many of the configurations can be common with the UL-WUS configuration. This optional parameter rule (of determining a default value for UL-WUS parameters) may be supported only if RACH occasions are shared for the UL-WUS and other purposes. If the UE 420 determines that common occasions are used, the UE 420 may expect that RACH parameters are also applicable to the UL-WUS (such as power-related parameters). Whether the UE 420 can use RACH-related parameter values for the UL-WUS may be explicitly indicated.

In some aspects, when the NES cell 414 (e.g., Cell A or NES Cell 1) provides the UL-WUS configuration 402 for multiple NES cells (when operation 425 is to be performed), and if some UL-WUS configuration parameters for one or multiple NES cells are missing, the UE 420 may use an optional parameter rule that indicates or specifies that the associated values for a NES cell (a reference NES Cell) from a list of multiple NES cells (provided by Cell A or NES Cell 1) may be used for another one or multiple NES cell(s) with missing configurations. The anchor cell 412 may indicate which NES cell is the reference NES cell for this purpose. One NES cell may be the reference for all/multiple other NES cells.

In some aspects, for each NES cell or a list of NES cells, the associated reference NES cell for obtained values for optional parameters may be indicated. For each reference NES cell, the associated one or multiple NES cells may be indicated. For example, the first NES cell in the list (with associated configured parameters) may be used as a reference, or the reference NES cell may be a cell in the same frequency and band as the target NES cell (e.g., NES cell 414). The reference NES cell may have the same (DL and/or UL) SCS.

In some aspects, default values for the UL-WUS configuration 402 may be applicable to multiple NES cells by Cell A or NES Cell 1. Multiple default values may be indicated as being associated with an indicated list of NES cells, or with NES cells belonging to a given frequency/band.

In some aspects, the UE 420 may use any combination of the above operations. For example, the stored configuration information (standard defined) may indicate which parameters have default values. The anchor cell 412, the NES cell 414 (e.g., Cell A) or another NES cell may configure or indicate which parameters have default values, or values obtained from other sources. The indication may be cell-specific (Cell A-specific or specific to a NES cell or a group of NES cells), band-specific, specific to a UE or group of UEs, area-specific, or specific to a given duration of time. The UE 420 and cells may support reconfiguration and indication of changes. The adoption of a value of another parameters as a default value for an optional parameter for the UL-WUS may be based at least in part on whether the UE 420 has a stored value that is valid for such an optional parameter. While FIG. 4A shows an order of operations 435 through 450, these operations may be performed in other orders (e.g., operation 440 before operation 445). In some scenarios, operations 440 and 445 are not performed.

Example 400 in FIG. 4C shows that the network entity 415 use similar operations and described in FIGS. 4A and 4B to determine an optional parameter in the absence of an explicit indication of the optional parameter. As shown by reference number 470, the network entity 415 may transmit an indication of a reference cell (e.g., network entity 410 if the UE 420 is to use a parameter provided by another cell or reference cell.

As shown by reference number 475, the network entity 415 may determine that an optional parameter value is absent from the UL-WUS configuration 402. This is due to the fact that the network entity 410 did not include the optional parameter in the UL-WUS configuration 402. The network entity 415 may have information about this absent optional parameter or more detect the absence of the optional parameter. The network entity 415 is to expect that the UE 420 is to determine an optional parameter to use that is not explicitly indicated.

The network entity 415 may operate to determine a value for the optional parameter. As shown by reference number 480, the network entity 415 may determine that the UE 420 is to use an optional parameter rule (e.g., optional parameter rule 454) to determine the optional parameter. The network entity 415 is to use the same rule. For example, a RACH configuration 432 may include parameters that can be used to replace missing optional parameter values for the UL-WUS configuration 402. The anchor cell 412 or the NES cell 414 may indicate that the reference cell or the RACH configuration includes parameters that can be the determined value. The indication may be specific to a frequency band, a group of UEs, a geographic area, a duration, or a combination thereof. The network entity 415 may determine an optional parameter value (determined value 452) using the optional parameter rule 454.

In some aspects, the optional parameter rule 454 may indicate or specify that the UE 420 is to use a comparable RACH parameter 434 from the RACH configuration 432. This may include different options. The UE 420 (and the network entity 415) may obtain the value of the RACH parameter 434 as the determined value 452 for the optional parameter 436. Alternatively, in some aspects, the optional parameter rule 454 may indicate or specify that the UE 420 (and the network entity 415) is to use a default rule in stored configuration information for the determined value 452 for the optional parameter 436. The UE 420 (and the network entity 415) may obtain the default value as the determined value 452. The network entity 415 may receive an UL-WUS to the NES cell 414 using the determined value 452 for the optional parameter 436.

In some aspects, the optional parameter rule may indicate or specify that values configured or indicated for other similar parameters may be applicable for the UL-WUS configuration parameters. When the UL-WUS configuration 402 (for a NES Cell 1) is provided by a second cell (e.g., Cell A or a NES cell 2) in operation 425, and some UL-WUS optional parameters do not have values in the UL-WUS configuration, the UE 420 may expect the same values configured for the similar parameters of Cell A (or NES Cell 2). The network entity 415 may use the same values.

In another example of an optional parameter rule, when the UL-WUS configuration 402 is provided by the NES cell 414 itself (such as when operation 425 is to be performed), and some of the UL-WUS optional parameters are not configured, the UE 420 may expect the same values configured for other/similar parameters of the NES cell 414. The network entity 415 may use these same values.

In some aspects, when the NES cell 414 (e.g., Cell A or NES Cell 1) provides the UL-WUS configuration 402 for multiple NES cells, and if some UL-WUS configuration parameters for one or multiple NES cells are missing, the UE 420 may use an optional parameter rule that indicates or specifies that the associated values for a NES cell (a reference NES Cell) from a list of multiple NES cells (provided by Cell A or NES Cell 1) may be used for another one or multiple NES cell(s) with missing configurations. The anchor cell 412 may indicate which NES cell is the reference NES cell for this purpose. One NES cell may be the reference for all/multiple other NES cells. The network entity 415 may use an optional parameter of the reference NES cell. In some aspects, the network entity 415 may use any combination of the above operations.

As indicated above, FIGS. 4A, 4B, and 4C are provided as an example. Other examples may differ from what is described with regard to FIGS. 4A,4B, and 4C.

FIG. 5 is a diagram illustrating an example process 500 performed, for example, at a UE or an apparatus of a UE. Example process 500 is an example where the apparatus or the UE (e.g., UE 420) performs operations associated with determining an optional parameter value for an UL-WUS.

As shown in FIG. 5, in some aspects, process 500 may include receiving an UL-WUS configuration for a first cell (block 510). For example, the UE (e.g., using communication manager 150 or reception component 602, depicted in FIG. 6) may receive an UL-WUS configuration for a first cell, as described above.

As further shown in FIG. 5, in some aspects, process 500 may include transmitting, based at least in part on a determination that a value of an optional parameter of the UL-WUS configuration is absent, an UL-WUS that uses a value of the optional parameter determined based at least in part on an optional parameter rule (block 520). For example, the UE (e.g., using communication manager 150 or transmission component 604, depicted in FIG. 6) may transmit, based at least in part on a determination that a value of an optional parameter of the UL-WUS configuration is absent, an UL-WUS that uses a value of the optional parameter determined based at least in part on an optional parameter rule, as described above.

Process 500 may include additional aspects, such as any single aspect or any combination of aspects described below or in connection with one or more other processes described elsewhere herein.

In a first aspect, the optional parameter rule indicates that the determined value of the optional parameter is a default value obtained from stored configuration information, and process 500 includes obtaining the default value from the stored configuration information.

In a second aspect, alone or in combination with the first aspect, the optional parameter rule indicates that the determined value of the optional parameter is to be obtained from a set of parameters associated with a second cell, and process 500 includes obtaining the determined value from the set of parameters.

In a third aspect, alone or in combination with one or more of the first and second aspects, a parameter of the set of parameters corresponds to the optional parameter.

In a fourth aspect, alone or in combination with one or more of the first through third aspects, process 500 includes determining that the second cell is a reference cell for the optional parameter.

In a fifth aspect, alone or in combination with one or more of the first through fourth aspects, determining that the second cell is a reference cell includes receiving an indication that the second cell provided the determined value.

In a sixth aspect, alone or in combination with one or more of the first through fifth aspects, the indication is specific to a cell, a frequency band, a group of UEs, a geographic area, a duration, or a combination thereof.

In a seventh aspect, alone or in combination with one or more of the first through sixth aspects, the second cell has a same frequency band or subcarrier spacing as the first cell.

In an eighth aspect, alone or in combination with one or more of the first through seventh aspects, the optional parameter rule indicates that the determined value is to be obtained from a system information block one (SIB1), and process 500 includes obtaining the determined value from a received SIB1.

In a ninth aspect, alone or in combination with one or more of the first through eighth aspects, the optional parameter rule indicates that the determined value is to be obtained from a RACH configuration, and process 500 includes obtaining the determined value from a received RACH configuration.

In a tenth aspect, alone or in combination with one or more of the first through ninth aspects, process 500 includes determining that the RACH configuration includes one or more parameters available for UL-WUS.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram of an example apparatus 600 for wireless communication. The apparatus 600 may be a UE, or a UE may include the apparatus 600. In some aspects, the apparatus 600 includes a reception component 602 and a transmission component 604, which may be in communication with one another (for example, via one or more buses or one or more other components). As shown, the apparatus 600 may communicate with another apparatus 606 (such as a UE, a base station, or another wireless communication device) using the reception component 602 and the transmission component 604. As further shown, the apparatus 600 may include the communication manager 150. The communication manager 150 may include one or more of a configuration component 608 or a determination component 610, among other examples. The communication manager 150 may be included in, or implemented via, a processing system (for example, the processing system 140 described in connection with FIG. 1) of the UE.

In some aspects, the apparatus 600 may be configured to perform one or more operations described herein in connection with FIGS. 1-4B. Additionally, or alternatively, the apparatus 600 may be configured to perform one or more processes described herein, such as process 500 of FIG. 5. In some aspects, the apparatus 600 or one or more components shown in FIG. 6 may include one or more components of the UE described in connection with FIG. 1. Additionally, or alternatively, one or more components shown in FIG. 6 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 602 may receive communications, such as reference signals, control information, data communications, or a combination thereof, from the apparatus 606. The reception component 602 may provide received communications to one or more other components of the apparatus 600. In some aspects, the reception component 602 may perform signal processing on the received communications, and may provide the processed signals to the one or more other components of the apparatus 600. In some aspects, the reception component 602 may include one or more components of the UE described above in connection with FIG. 1, such as a radio, one or more RF chains, one or more transceivers, or one or more modems, each of which may in turn be coupled with one or more antennas of the UE.

The transmission component 604 may transmit communications, such as reference signals, control information, data communications, or a combination thereof, to the apparatus 606. In some aspects, one or more other components of the apparatus 600 may generate communications and may provide the generated communications to the transmission component 604 for transmission to the apparatus 606. In some aspects, the transmission component 604 may perform signal processing on the generated communications (such as filtering, amplification, modulation, digital-to-analog conversion, multiplexing, interleaving, mapping, or encoding, among other examples), and may transmit the processed signals to the apparatus 606. In some aspects, the transmission component 604 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 604 may be co-located with the reception component 602.

The reception component 602 may receive an UL-WUS configuration for a first cell. The configuration component 608 may determine that a value of an optional parameter is absent. The transmission component 604 may transmit, based at least in part on a determination that a value of an optional parameter of the UL-WUS configuration is absent, an UL-WUS that uses a value of the optional parameter determined based at least in part on an optional parameter rule.

The determination component 610 may determine that the second cell is a reference cell for the optional parameter. The determination component 610 may determine that the RACH configuration includes one or more parameters available for UL-WUS.

The number and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally, or alternatively, a set of (one or more) components shown in FIG. 6 may perform one or more functions described as being performed by another set of components shown in FIG. 6.

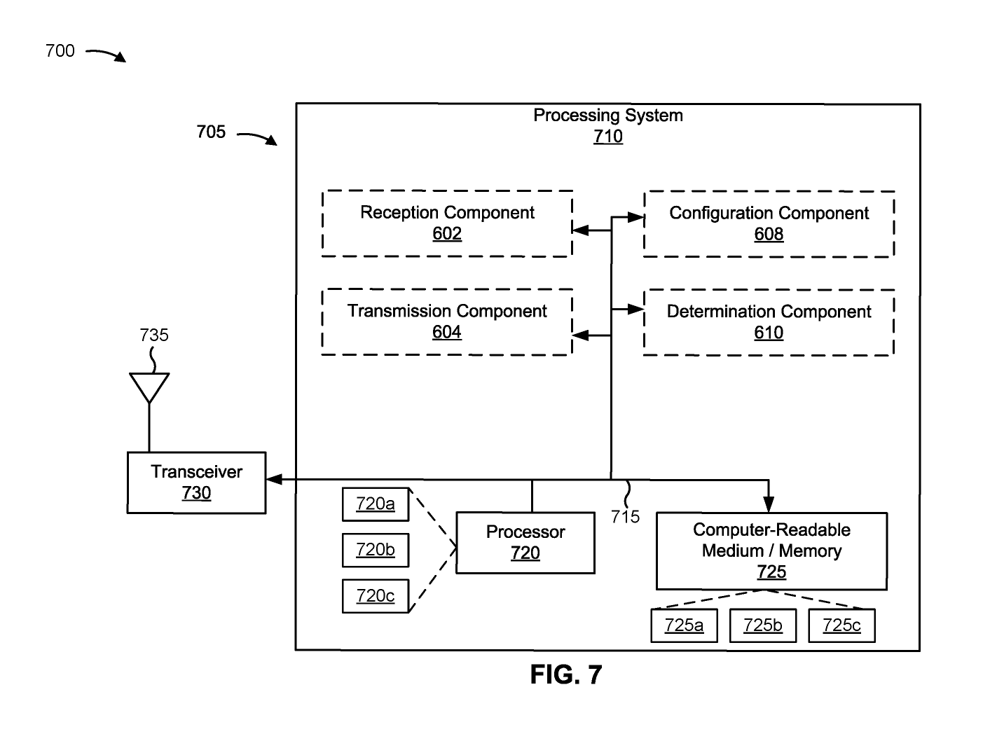

FIG. 7 is a diagram illustrating an example 700 of a hardware implementation for an apparatus 705 employing a processing system 710. The apparatus 705 may be a UE or may be at (e.g., included in) a UE. The processing system 710 may be, or may be similar to, the processing system 140 of the UE 120 described in connection with FIG. 1.

The processing system 710 may be implemented with a bus architecture, represented generally by the bus 715. The bus 715 may include any number of interconnecting buses and bridges depending on the specific application of the processing system 710 and the overall design constraints. The bus 715 links together various circuits including one or more processors or hardware components, represented by the processor (or processing circuitry) 720, the illustrated components, and the computer-readable medium / memory (or memory circuitry) 725. The processor 720 may include multiple processors, such as processor 720a, processor 720b, and processor 720c. The memory 725 may include multiple memories, such as memory 725a, memory 725b, and memory 725c The bus 715 may also link various other circuits, such as timing sources, peripherals, voltage regulators, or power management circuits.

The processing system 710 may be coupled to one or more transceivers 730. A transceiver 730 is coupled to one or more antennas 735. The transceiver 730 provides a means for communicating with various other apparatuses over a transmission medium. The transceiver 730 receives a signal from the one or more antennas 735, extracts information from the received signal, and provides the extracted information to the processing system 710, specifically the reception component 602. In addition, the transceiver 730 receives information from the processing system 710, specifically the transmission component 604, and generates a signal to be applied to the one or more antennas 735 based at least in part on the received information.

The processing system 710 includes one or more processors 720 coupled to a computer-readable medium / memory 725. A processor 720 is responsible for general processing, including the execution of software stored on the computer-readable medium / memory 725. The software, when executed by the processor 720, causes the processing system 710 to perform the various functions described herein for any particular apparatus. The computer-readable medium / memory 725 may also be used for storing data that is manipulated by the processor 720 when executing software. The processing system further includes at least one of the illustrated components. The components may be software modules running in the processor 720, resident/stored in the computer readable medium / memory 725, one or more hardware modules coupled to the processor 720, or some combination thereof.

In some aspects, the processing system 710 may be a component of the UE 120 or may be, may include, or may be included in the processing system 140 of the UE 120 described in connection with FIG. 1. In some aspects, the apparatus 705 for wireless communication includes means for means for receiving an UL-WUS configuration for a first cell; and means for transmitting, based at least in part on a determination that a value of an optional parameter of the UL-WUS configuration is absent, an UL-WUS that uses a value of the optional parameter determined based at least in part on an optional parameter rule. The aforementioned means may be one or more of the aforementioned components of the apparatus 600 or the processing system 710 of the apparatus 705 configured to perform the functions recited by the aforementioned means. As described elsewhere herein, the processing system 710 may include one or more components of the processing system 140 of the UE 120 described in connection with FIG. 1. In one configuration, the aforementioned means may be the processing system 140 or one or more components of the processing system 140 configured to perform the functions or operations recited herein.

FIG. 7 is provided as an example. Other examples may differ from what is described in connection with FIG. 7.

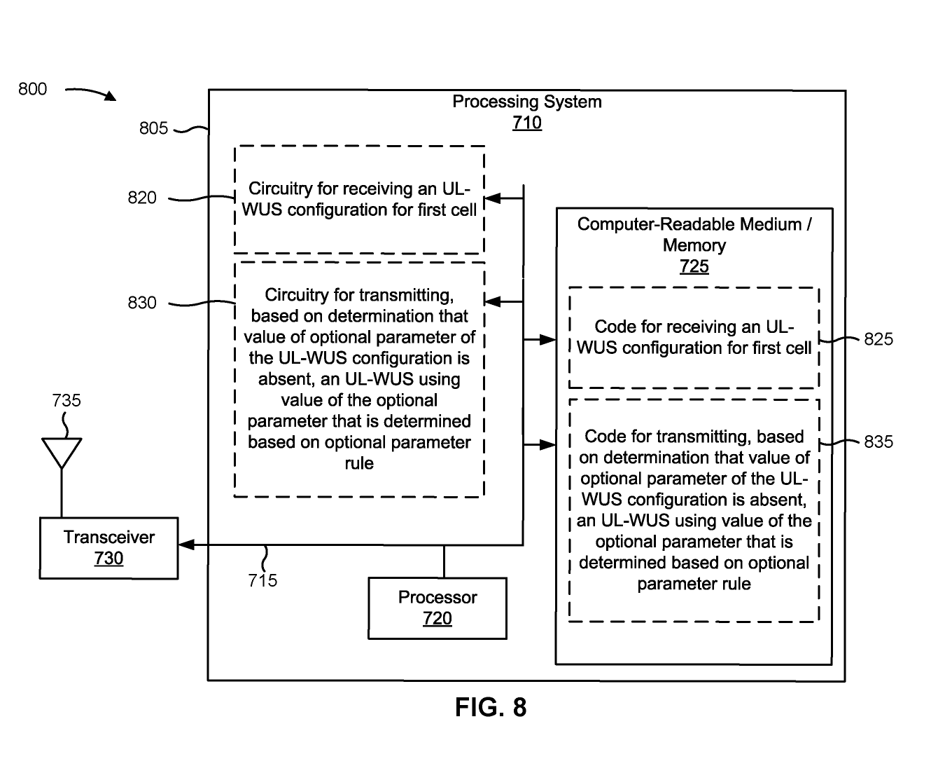

FIG. 8 is a diagram illustrating an example 800 of an implementation of code and circuitry for an apparatus 805. The apparatus 805 may be a UE, or a UE may include the apparatus 805.

As shown in FIG. 8, the apparatus 805 may include circuitry for receiving an UL-WUS configuration for a first cell (circuitry 820). For example, the circuitry 820 may enable the apparatus 805 to receive an UL-WUS configuration for a first cell.

As shown in FIG. 8, the apparatus 805 may include, stored in computer-readable medium 725, code for receiving an UL-WUS configuration for a first cell (code 825). For example, the code 825, when executed by processor 720, may cause processor 720 to cause transceiver 730 to receive an UL-WUS configuration for a first cell.

As shown in FIG. 8, the apparatus 805 may include circuitry for transmitting, based at least in part on a determination that a value of an optional parameter of the UL-WUS configuration is absent, an UL-WUS that uses a value of the optional parameter determined based at least in part on an optional parameter rule (circuitry 830). For example, the circuitry 830 may enable the apparatus 805 to transmit, based at least in part on a determination that a value of an optional parameter of the UL-WUS configuration is absent, an UL-WUS that uses a value of the optional parameter determined based at least in part on an optional parameter rule.

As shown in FIG. 8, the apparatus 805 may include, stored in computer-readable medium 725, code for transmitting, based at least in part on a determination that a value of an optional parameter of the UL-WUS configuration is absent, an UL-WUS that uses a value of the optional parameter determined based at least in part on an optional parameter rule (code 835). For example, the code 835, when executed by processor 720, may cause processor 720 to cause transceiver 730 to transmit, based at least in part on a determination that a value of an optional parameter of the UL-WUS configuration is absent, an UL-WUS that uses a value of the optional parameter determined based at least in part on an optional parameter rule.

FIG. 8 is provided as an example. Other examples may differ from what is described in connection with FIG. 8.

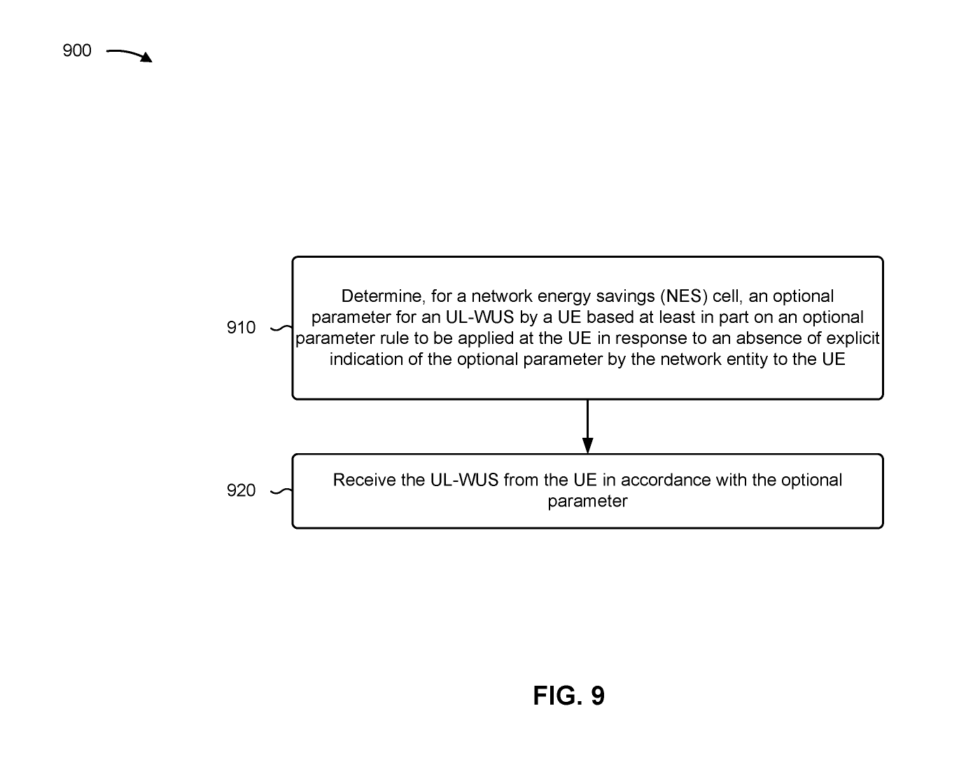

FIG. 9 is a diagram illustrating an example process 900 performed, for example, at a network entity or an apparatus of a network entity. Example process 900 is an example where the apparatus or the network entity (e.g., network entity 415) performs operations associated with optional parameter value for UL-WUS.

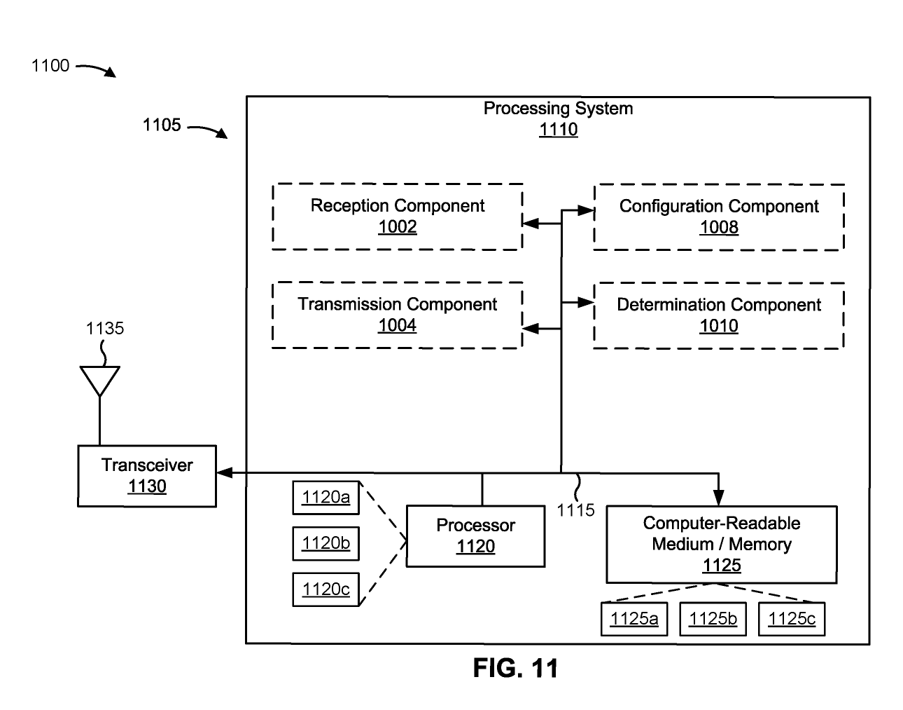

As shown in FIG. 9, in some aspects, process 900 may include determining, for an NES cell, an optional parameter for an UL-WUS by an UE based at least in part on an optional parameter rule to be applied at the UE in response to an absence of explicit indication of the optional parameter by the network entity to the UE (block 910). For example, the network entity (e.g., the processing system 1110, the processor 1120, the memory 1125, or the one or more antennas 1135, depicted in FIG. 11, or communication manager 155 or determination component 1010, depicted in FIG. 10) may determine, for an NES cell, an optional parameter for an UL-WUS by an UE based at least in part on an optional parameter rule to be applied at the UE in response to an absence of explicit indication of the optional parameter by the network entity to the UE, as described above.

As further shown in FIG. 9, in some aspects, process 900 may include receiving the UL-WUS from the UE in accordance with the optional parameter (block 920). For example, the network entity (e.g., the processing system 1110, the processor 1120, the memory 1125, or the one or more antennas 1135, depicted in FIG. 11, or communication manager 155 or reception component 1002, depicted in FIG. 10) may receive the UL-WUS from the UE in accordance with the optional parameter, as described above.

Process 900 may include additional aspects, such as any single aspect or any combination of aspects described below or in connection with one or more other processes described elsewhere herein.

In a first aspect, the optional parameter rule comprises selecting a default value for the optional parameter from stored configuration information.

In a second aspect, alone or in combination with the first aspect, the optional parameter rule comprises selecting the optional parameter from a set of parameters associated with a reference cell.

In a third aspect, alone or in combination with one or more of the first and second aspects, process 900 includes transmitting an indication of the reference cell to the UE.

In a fourth aspect, alone or in combination with one or more of the first through third aspects, the indication is specific to a cell, a frequency band, a group of UEs, a geographic area, a duration, or a combination thereof.

In a fifth aspect, alone or in combination with one or more of the first through fourth aspects, process 900 includes selecting the optional parameter from an SIB1 transmitted for the NES cell.

In a sixth aspect, alone or in combination with one or more of the first through fifth aspects, process 900 includes selecting the optional parameter from an RACH configuration received for the NES cell.

In a seventh aspect, alone or in combination with one or more of the first through sixth aspects, the reference cell has a same frequency band or subcarrier spacing as the NES cell.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication. The apparatus 1000 may be a network entity, or a network entity may include the apparatus 1000. In some aspects, the apparatus 1000 includes a reception component 1002 and a transmission component 1004, which may be in communication with one another (for example, via one or more buses or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 150. The communication manager 155 may include one or more of a configuration component 1008 or a determination component 1010, among other examples. The communication manager 150 may be included in, or implemented via, a processing system (for example, the processing system 145 described in connection with FIG. 1) of the network entity.

In some aspects, the apparatus 1000 may be configured to perform one or more operations described herein in connection with FIGS. 1-4C. Additionally, or alternatively, the apparatus 1000 may be configured to perform one or more processes described herein, such as process 900 of FIG. 9. In some aspects, the apparatus 1000 or one or more components shown in FIG. 10 may include one or more components of the network node described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1004 may be co-located with the reception component 1002.

The reception component 1002 may receive an UL-WUS for a first cell. The determination component 1010 may determine that a value of an optional parameter is absent and determine an optional parameter that a UE is to use using an optional parameter rule.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram illustrating an example 1100 of a hardware implementation for an apparatus 1105 employing a processing system 1110. The apparatus 1105 may be a network entity or may be at (e.g., included in) a network entity. The processing system 1110 may be, or may be similar to, the processing system 145 of the network node 110 described in connection with FIG. 1.

The processing system 1110 may be implemented with a bus architecture, represented generally by the bus 1115. The bus 1115 may include any number of interconnecting buses and bridges depending on the specific application of the processing system 1110 and the overall design constraints. The bus 1115 links together various circuits including one or more processors or hardware components, represented by the processor (or processing circuitry) 1120, the illustrated components, and the computer-readable medium / memory (or memory circuitry) 1125. The processor 1120 may include multiple processors, such as processor 1120a, processor 1120b, and processor 1120c. The memory 1125 may include multiple memories, such as memory 1125a, memory 1125b, and memory 1125c The bus 1115 may also link various other circuits, such as timing sources, peripherals, voltage regulators, or power management circuits.

The processing system 1110 may be coupled to one or more transceivers 1130. A transceiver 1130 is coupled to one or more antennas 1135. The transceiver 1130 provides a means for communicating with various other apparatuses over a transmission medium. The transceiver 1130 receives a signal from the one or more antennas 1135, extracts information from the received signal, and provides the extracted information to the processing system 1110, specifically the reception component 1002. In addition, the transceiver 1130 receives information from the processing system 1110, specifically the transmission component 1004, and generates a signal to be applied to the one or more antennas 1135 based at least in part on the received information.

The processing system 1110 includes one or more processors 1120 coupled to a computer-readable medium / memory 1125. A processor 1120 is responsible for general processing, including the execution of software stored on the computer-readable medium / memory 1125. The software, when executed by the processor 1120, causes the processing system 1110 to perform the various functions described herein for any particular apparatus. The computer-readable medium / memory 1125 may also be used for storing data that is manipulated by the processor 1120 when executing software. The processing system further includes at least one of the illustrated components. The components may be software modules running in the processor 1120, resident/stored in the computer readable medium / memory 1125, one or more hardware modules coupled to the processor 1120, or some combination thereof.

In some aspects, the processing system 1110 may be a component of the network node 110 or may be, may include, or may be included in the processing system 145 of the network node 110 described in connection with FIG. 1. In some aspects, the apparatus 1105 for wireless communication includes means for determining, for a NES cell, an optional parameter for an UL-WUS by a UE based at least in part on an optional parameter rule to be applied at the UE in response to an absence of explicit indication of the optional parameter by the network entity to the UE; and means for receiving the UL-WUS from the UE in accordance with the optional parameter. The aforementioned means may be one or more of the aforementioned components of the apparatus 1000 or the processing system 1110 of the apparatus 1105 configured to perform the functions recited by the aforementioned means. As described elsewhere herein, the processing system 1110 may include one or more components of the processing system 145 of the network node 110 described in connection with FIG. 1. In one configuration, the aforementioned means may be the processing system 145 or one or more components of the processing system 145 configured to perform the functions or operations recited herein.

FIG. 11 is provided as an example. Other examples may differ from what is described in connection with FIG. 1.

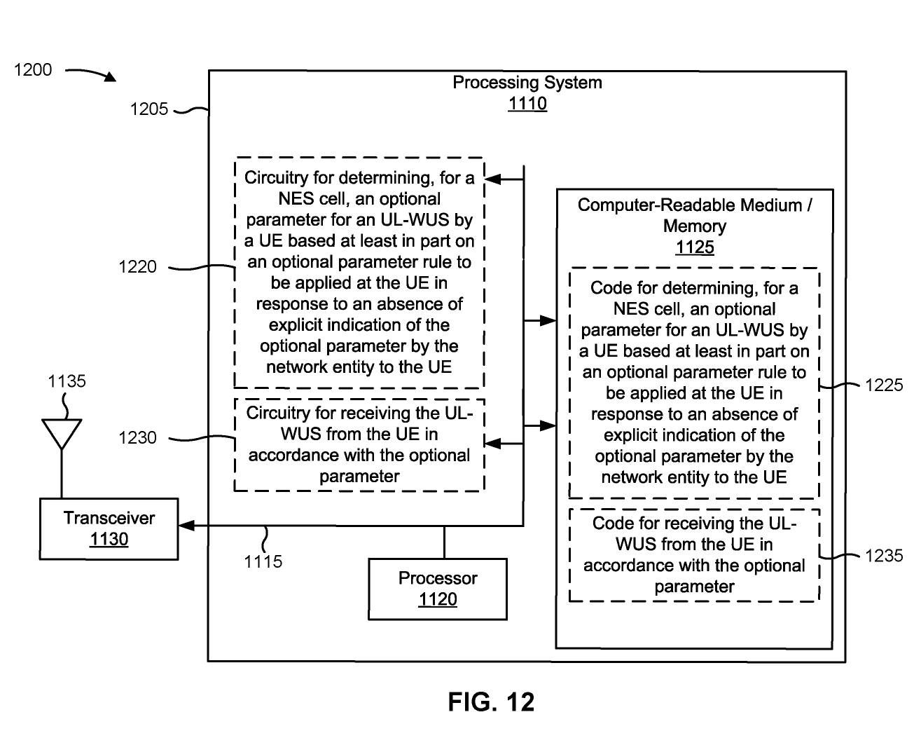

FIG. 12 is a diagram illustrating an example 1200 of an implementation of code and circuitry for an apparatus 1205. The apparatus 1205 may be a UE, or a UE may include the apparatus 1205.

As shown in FIG. 12, the apparatus 1205 may include circuitry for determining, for a NES cell, an optional parameter for an UL-WUS by a UE based at least in part on an optional parameter rule to be applied at the UE in response to an absence of explicit indication of the optional parameter by the network entity to the UE (circuitry 1220). For example, the circuitry 1220 may enable the apparatus 1205 to determine, for a NES cell, an optional parameter for an UL-WUS by a UE based at least in part on an optional parameter rule to be applied at the UE in response to an absence of explicit indication of the optional parameter by the network entity to the UE.

As shown in FIG. 12, the apparatus 1205 may include, stored in computer-readable medium 1125, code for determining, for a NES cell, an optional parameter for an UL-WUS by a UE based at least in part on an optional parameter rule to be applied at the UE in response to an absence of explicit indication of the optional parameter by the network entity to the UE (code 1225). For example, the code 1225, when executed by processor 1120, may cause processor 1120 to cause transceiver 1130 to determine, for a NES cell, an optional parameter for an UL-WUS by a UE based at least in part on an optional parameter rule to be applied at the UE in response to an absence of explicit indication of the optional parameter by the network entity to the UE.

As shown in FIG. 12, the apparatus 1205 may include circuitry for receiving the UL-WUS from the UE in accordance with the optional parameter (circuitry 1230). For example, the circuitry 1230 may enable the apparatus 1205 to receive the UL-WUS from the UE in accordance with the optional parameter.

As shown in FIG. 12, the apparatus 1205 may include, stored in computer-readable medium 1125, code for transmitting, based at least in part on a determination that a value of an optional parameter of the UL-WUS configuration is absent, an UL-WUS that uses a value of the optional parameter determined based at least in part on an optional parameter rule (code 1235). For example, the code 1235, when executed by processor 1120, may cause processor 1120 to cause transceiver 1130 to transmit, based at least in part on a determination that a value of an optional parameter of the UL-WUS configuration is absent, an UL-WUS that uses a value of the optional parameter determined based at least in part on an optional parameter rule.

FIG. 12 is provided as an example. Other examples may differ from what is described in connection with FIG. 12.

The following provides an overview of some Aspects of the present disclosure:

Aspect 1: A method of wireless communication performed at a user equipment (UE), comprising: receiving an uplink (UL) wake up signal (WUS) configuration for a first cell; and transmitting, based at least in part on a determination that a value of an optional parameter of the UL-WUS configuration is absent, an UL-WUS that uses a value of the optional parameter determined based at least in part on an optional parameter rule.

Aspect 2: The method of Aspect 1, wherein the optional parameter rule indicates that the determined value of the optional parameter is a default value obtained from stored configuration information, and wherein the method further comprises obtaining the default value from the stored configuration information.

Aspect 3: The method of any of Aspects 1-2, wherein the optional parameter rule indicates that the determined value of the optional parameter is to be obtained from a set of parameters associated with a second cell, and wherein the method further comprises obtaining the determined value from the set of parameters.

Aspect 4: The method of Aspect 3, wherein a parameter of the set of parameters corresponds to the optional parameter.

Aspect 5: The method of Aspect 3, further comprising determining that the second cell is a reference cell for the optional parameter.

Aspect 6: The method of Aspect 5, wherein determining that the second cell is a reference cell includes receiving an indication that the second cell provided the determined value.

Aspect 7: The method of Aspect 6, wherein the indication is specific to a cell, a frequency band, a group of UEs, a geographic area, a duration, or a combination thereof.

Aspect 8: The method of Aspect 3, wherein the second cell has a same frequency band or subcarrier spacing as the first cell.

Aspect 9: The method of any of Aspects 1-8, wherein the optional parameter rule indicates that the determined value is to be obtained from a system information block one (SIB1), and wherein the method includes obtaining the determined value from a received SIB1.

Aspect 10: The method of any of Aspects 1-9, wherein the optional parameter rule indicates that the determined value is to be obtained from a random access channel (RACH) configuration, and wherein the method further comprises obtaining the determined value from a received RACH configuration.

Aspect 11: The method of Aspect 10, further comprising determining that the RACH configuration includes one or more parameters available for UL-WUS.

Aspect 12: A method of wireless communication performed at a network entity, comprising: determining, for a network energy savings (NES) cell, an optional parameter for an uplink wake-up signal (UL-WUS) by a user equipment (UE) based at least in part on an optional parameter rule to be applied at the UE in response to an absence of explicit indication of the optional parameter by the network entity to the UE; and receiving the UL-WUS from the UE in accordance with the optional parameter.

Aspect 13: The method of Aspect 12, wherein the optional parameter rule comprises selecting a default value for the optional parameter from stored configuration information.

Aspect 14: The method of any of Aspects 12-13, wherein the optional parameter rule comprises selecting the optional parameter from a set of parameters associated with a reference cell.

Aspect 15: The method of Aspect 14, further comprising transmitting an indication of the reference cell to the UE.

Aspect 16: The method of Aspect 15, wherein the indication is specific to a cell, a frequency band, a group of UEs, a geographic area, a duration, or a combination thereof.

Aspect 17: The method of any of Aspects 12-16, further comprising selecting the optional parameter from a system information block one (SIB1) transmitted for the NES cell.

Aspect 18: The method of any of Aspects 12-17, further comprising selecting the optional parameter from random access channel (RACH) configuration received for the NES cell.

Aspect 19: The method of any of Aspects 12-18, wherein the reference cell has a same frequency band or subcarrier spacing as the NES cell.

Aspect 20: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-19.

Aspect 21: An apparatus for wireless communication at a device, the apparatus comprising one or more memories and one or more processors coupled to the one or more memories, the one or more processors configured to cause the device to perform the method of one or more of Aspects 1-19.

Aspect 22: An apparatus for wireless communication, the apparatus comprising at least one means for performing the method of one or more of Aspects 1-19.

Aspect 23: A non-transitory computer-readable medium storing code for wireless communication, the code comprising instructions executable by one or more processors to perform the method of one or more of Aspects 1-19.

Aspect 24: A non-transitory computer-readable medium storing a set of instructions for wireless communication, the set of instructions comprising one or more instructions that, when executed by one or more processors of a device, cause the device to perform the method of one or more of Aspects 1-19.

Aspect 25: A device for wireless communication, the device comprising a processing system that includes one or more processors and one or more memories coupled with the one or more processors, the processing system configured to cause the device to perform the method of one or more of Aspects 1-19.

Aspect 26: An apparatus for wireless communication at a device, the apparatus comprising one or more memories and one or more processors coupled to the one or more memories, the one or more processors individually or collectively configured to cause the device to perform the method of one or more of Aspects 1-19.

Aspect 27: A device comprising one or more antennas, and a processing system that includes one or more processors and one or more memories that store code and are coupled with the one or more processors, the processing system configured to cause the device to perform the method of one or more of Aspects 1-19.

Aspect 28: A device comprising one or more antennas, and a processing system that includes processor circuitry and memory circuitry that stores code, the processing system configured to cause the device to perform the method of one or more of Aspects 1-19.

Aspect 29: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-19.

Aspect 30: An apparatus for wireless communication at a device, the apparatus comprising one or more memories and one or more processors coupled to the one or more memories, the one or more processors configured to cause the device to perform the method of one or more of Aspects 1-19.

Aspect 31: An apparatus for wireless communication, the apparatus comprising at least one means for performing the method of one or more of Aspects 1-19.

Aspect 32: A non-transitory computer-readable medium storing code for wireless communication, the code comprising instructions executable by one or more processors to perform the method of one or more of Aspects 1-19.

Aspect 33: A non-transitory computer-readable medium storing a set of instructions for wireless communication, the set of instructions comprising one or more instructions that, when executed by one or more processors of a device, cause the device to perform the method of one or more of Aspects 1-19.

Aspect 34: A device for wireless communication, the device comprising a processing system that includes one or more processors and one or more memories coupled with the one or more processors, the processing system configured to cause the device to perform the method of one or more of Aspects 1-19.

Aspect 35: An apparatus for wireless communication at a device, the apparatus comprising one or more memories and one or more processors coupled to the one or more memories, the one or more processors individually or collectively configured to cause the device to perform the method of one or more of Aspects 1-19.

Aspect 36: A device comprising a processing system that includes one or more processors and one or more code-storing memories coupled with the one or more processors, the processing system configured to cause the device to perform the method of one or more of Aspects 1-19.

Aspect 37: A device comprising a processing system that includes processor circuitry and code-storing memory circuitry, the processing system configured to cause the device to perform the method of one or more of Aspects 1-19.

Aspect 38: An apparatus for wireless communication at a user equipment (UE), comprising: one or more memories; and one or more processors coupled to the one or more memories, the one or more processors configured to cause the UE to: receive an uplink (UL) wake up signal (WUS) configuration for a first cell; and transmit, based at least in part on a determination that a value of an optional parameter of the UL-WUS configuration is absent, an UL-WUS that uses a value of the optional parameter determined based at least in part on an optional parameter rule.

Aspect 39: The apparatus of Aspect 38, wherein the one or more processors are configured, individually or collectively, to cause the UE to: receive an uplink (UL) wake up signal (WUS) configuration for a first cell; and transmit, based at least in part on a determination that a value of an optional parameter of the UL-WUS configuration is absent, an UL-WUS that uses a value of the optional parameter determined based at least in part on an optional parameter rule.

Aspect 40: An apparatus for wireless communication at a network entity, comprising: one or more memories; and one or more processors coupled to the one or more memories, the one or more processors configured to cause the network entity to: determine, for a network energy savings (NES) cell, an optional parameter for an uplink wake-up signal (UL-WUS) by a user equipment (UE) based at least in part on an optional parameter rule to be applied at the UE in response to an absence of explicit indication of the optional parameter by the network entity to the UE; and receive the UL-WUS from the UE in accordance with the optional parameter.

Aspect 41: The apparatus of Aspect 40, wherein the one or more processors are configured, individually or collectively, to cause the network entity to: determine, for a network energy savings (NES) cell, an optional parameter for an uplink wake-up signal (UL-WUS) by a user equipment (UE) based at least in part on an optional parameter rule to be applied at the UE in response to an absence of explicit indication of the optional parameter by the network entity to the UE; and receive the UL-WUS from the UE in accordance with the optional parameter.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors coupled with the one or more memories and configured to cause the UE to:
receive an uplink (UL) wake up signal (WUS) configuration for a first cell; and
transmit, based at least in part on a determination that a value of an optional parameter of the UL-WUS configuration is absent, an UL-WUS that uses a value of the optional parameter determined based at least in part on an optional parameter rule.

2. The apparatus of claim 1, wherein the optional parameter rule indicates that the determined value of the optional parameter is a default value obtained from stored configuration information, and wherein the one or more processors are configured to cause the UE to obtain the default value from the stored configuration information.

3. The apparatus of claim 1, wherein the optional parameter rule indicates that the determined value of the optional parameter is to be obtained from a set of parameters associated with a second cell, and wherein the one or more processors are configured to cause the UE to obtain the determined value from the set of parameters.

4. The apparatus of claim 3, wherein a parameter of the set of parameters corresponds to the optional parameter.

5. The apparatus of claim 3, wherein the one or more processors are configured to cause the UE to determine that the second cell is a reference cell for the optional parameter.

6. The apparatus of claim 5, wherein to determine that the second cell is a reference cell, the one or more processors are configured to cause the UE to receive an indication that the second cell provided the determined value.

7. The apparatus of claim 6, wherein the indication is specific to a cell, a frequency band, a group of UEs, a geographic area, a duration, or a combination thereof.

8. The apparatus of claim 3, wherein the second cell has a same frequency band or subcarrier spacing as the first cell.

9. The apparatus of claim 1, wherein the optional parameter rule indicates that the determined value is to be obtained from a system information block one (SIB1), and wherein the one or more processors are configured to cause the UE to obtain the determined value from a received SIB1.

10. The apparatus of claim 1, wherein the optional parameter rule indicates that the determined value is to be obtained from a random access channel (RACH) configuration, and wherein the one or more processors are configured to cause the UE to obtain the determined value from a received RACH configuration.

11. The apparatus of claim 10, wherein the one or more processors are configured to cause the UE to determine that the RACH configuration includes one or more parameters available for UL-WUS.

12. A method of wireless communication performed at a user equipment (UE), comprising:
receiving an uplink (UL) wake up signal (WUS) configuration for a first cell; and
transmitting, based at least in part on a determination that a value of an optional parameter of the UL-WUS configuration is absent, an UL-WUS that uses a value of the optional parameter that is determined based at least in part on an optional parameter rule.

13. An apparatus for wireless communication at a network entity, comprising:
one or more memories; and
one or more processors coupled with the one or more memories and configured to cause the network entity to:
determine, for a network energy savings (NES) cell, an optional parameter for an uplink wake-up signal (UL-WUS) from a user equipment (UE) based at least in part on an optional parameter rule to be applied at the UE in response to an absence of an explicit indication of the optional parameter to the UE; and
receive the UL-WUS from the UE in accordance with the optional parameter.

14. The apparatus of claim 13, wherein the optional parameter rule comprises selection of a default value for the optional parameter from stored configuration information.

15. The apparatus of claim 13, wherein the optional parameter rule comprises selection of the optional parameter from a set of parameters associated with a reference cell.

16. The apparatus of claim 15, wherein the one or more processors are configured to cause the network entity to transmit an indication of the reference cell to the UE.

17. The apparatus of claim 13, wherein the reference cell has a same frequency band or subcarrier spacing as the NES cell.

18. The apparatus of claim 17, wherein the indication is specific to a cell, a frequency band, a group of UEs, a geographic area, a duration, or a combination thereof.

19. The apparatus of claim 13, wherein the one or more processors are configured to cause the network entity to select the optional parameter from a system information block one (SIB1) transmitted for the NES cell.

20. The apparatus of claim 13, wherein the one or more processors are configured to cause the network entity to select the optional parameter from random access channel (RACH) configuration received for the NES cell.
